(19) United States
(12) Patent Application Publication
(10) Pub. No.: US 2023/0146407 A1
(43) Pub. Date: May 11, 2023

(54) CURABLE COMPOSITION, CURED PRODUCT, AND METHODS THEREOF

(71) Applicants: KANEKA AMERICAS HOLDING, INC., Pasadena, TX (US); KANEKA CORPORATION, Osaka (JP)

(72) Inventors: Haiqing YAO, Pasadena, TX (US); Young Hoon LIM, Pasadena, TX (US); Takeshi SUGIYAMA, Osaka (JP)

(21) Appl. No.: 17/917,654

(22) PCT Filed: Apr. 9, 2021
(86) PCT No.: PCT/US2021/026664

§ 371 Date: Oct. 7, 2022

Related U.S. Application Data
(60) Provisional application No. 63/007,423, filed on Apr. 9, 2020.

(51) Int. Cl. C08F 290/04; C08K 9/06; C08K 5/5415; C08K 3/22

(52) U.S. Cl. CPC C08F 290/042; C08K 9/06; C08K 5/5415; C08K 3/22; C08K 2003/222

(57) ABSTRACT

A curable composition includes a polymer having a terminal unit. The curable composition also includes a monomer polymerizable with the terminal unit of the polymer. The curable composition additionally includes an inorganic particle capable of absorbing moisture.

### PRIORITY CLAIM

The present application claims the priority of U.S. Provisional Application No. 63/007,423, filed Apr. 9, 2020, which is incorporated herein by reference in its entirety.

### BACKGROUND

Curable adhesives with high bonding strength and easy curability are useful for many applications. Curable adhesives having certain optical properties are often used in the production of visual displays.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a chart demonstrating a relationship between viscosity and polymer/monomer ratio, in accordance with some embodiments.

FIG. 2 is a set of optical microscopy images of a curable composition, in accordance with some embodiments.

FIG. 3 is a diagram of an inorganic particle, in accordance with some embodiments.

FIG. 4 is a chart comparing inorganic particles, in accordance with some embodiments.

FIG. 5 is a set of images of some exemplary inorganic particle dispersed in some exemplary curable compositions in accordance with some embodiments.

FIG. 6 is a chart showing dynamic vapor sorption (DVS) results of inorganic particles, in accordance with some embodiments.

FIG. 7 shows images of some exemplary curable compositions, in accordance with some embodiments.

FIG. 8 is a chart demonstrating the transparency of some exemplary cured products, in accordance with some embodiments.

FIG. 9 shows optical microscope images of some exemplary curable compositions in accordance with some embodiments (scale bar=50 um).

FIG. 10 is a chart demonstrating transmittance profile results of some exemplary cured products before and after humidity treatment, in accordance with some embodiments.

FIG. 11 is a schematic illustration of a CoCl₂ encapsulation experiment and water barrier properties of some exemplary cured products according to the CoCl₂ encapsulation experiment, in accordance with some embodiments.

FIG. 12 is a diagram of a method of preparing a curable composition, in accordance with some embodiments.

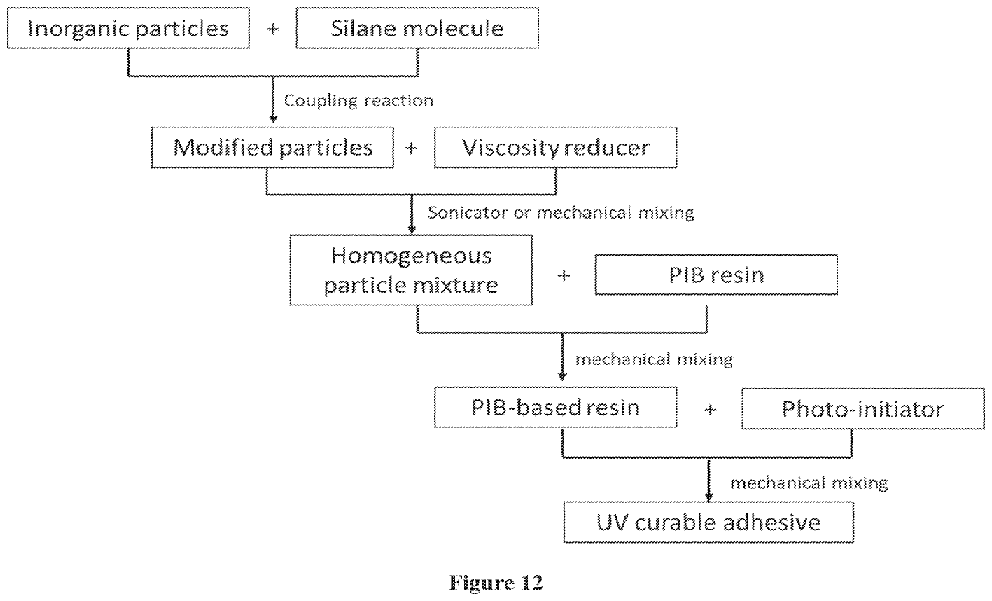

FIG. 13 is a diagram of a method of curing a curable composition, in accordance with some embodiments.

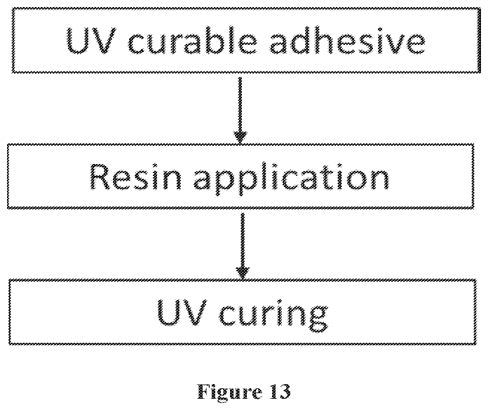

FIG. 14 is a side view of a device including a cured product, in accordance with some embodiments.

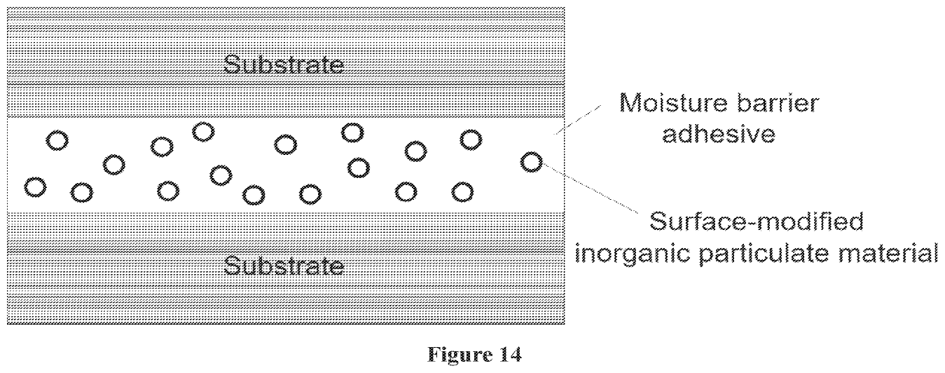

FIG. 15 is an inorganic particle, in accordance with some embodiments.

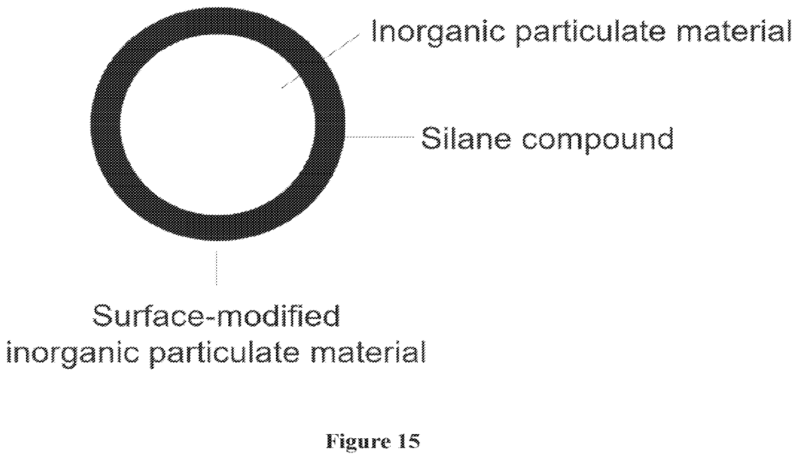

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” and the like, may be used herein for ease of description to describe one element or feature's relationship to another element(s) or feature(s) as illustrated in the figures. The spatially relative terms are intended to encompass different orientations of the device in use or operation, in addition to the orientation depicted in the figures. The apparatus may be otherwise oriented (rotated 90 degrees or at other orientations) and the spatially relative descriptors used herein may likewise be interpreted accordingly.

### Curable Composition

In some embodiments, the instant specification is directed to a curable composition.

In some embodiments, the curable composition is a curable composition having moisture barrier properties. In some embodiments, the curable composition results in a transparent and clear curing product.

In some embodiments, the curable composition is usable as an adhesive for use in an organic light-emitting diode (OLED) display. Organic materials used in OLEDs are often susceptible to moisture and oxygen absorption. Moisture and oxygen absorbed by the OLED display from the external environment often cause oxidation and crystallization of the organic materials, leading to dark spots and shortened shelf-life of the OLED devices. In some embodiments, the curable composition is a transparent adhesive for OLED side-seal application. One of ordinary skill in the art would understand that good moisture barrier properties are desirable in many applications other than OLED applications, as well. Therefore, the curable composition described in accordance with one or more embodiments is not limited to OLED applications.

In some embodiments, the curable composition includes a polymer having one or more terminal units; a monomer polymerizable with the terminal unit of the polymer; and an inorganic particle capable of absorbing moisture.

In some embodiments, a viscosity of the curable composition ranges from 1×10⁵ to 6×10⁵ cps. In some embodiments, the viscosity of the curable composition ranges from 2×10⁵ to 4×10⁵ cps. In some embodiments, the viscosity of the curable composition ranges from 2.5×10⁵ to 3×10⁵ cps. When the viscosity of the curable composition is in the above ranges, the application and curing of the curable composition during OLED production are conveniently carried out. However, when the curable composition is used in applications other than the OLED production, the viscosity range should be altered based on the requirements of that particular application. Methods of altering the viscosity of the curable composition are described below.

In some embodiments, the polymer is a hydrophobic polymer. As detailed above, in some embodiments, the curable composition is a curable composition for use in OLED production, wherein the curable composition is capable of reducing the passage of moisture through a side of the OLED device. A hydrophobic polymer results in improved moisture barrier performance by repelling water molecules. As used herein, the term “hydrophobic polymer” refers to polymers in which less than 5% of the repeat units have hydrophilic, polar, or charged functional groups, such as hydroxyl groups, carboxylic groups, amine groups, amide groups, or groups having similar or higher hydrophilicity. In some embodiments, the polymer is a hydrophobic polymer in which less than 2%, less than 1%, less than 0.1%, or less than 0.01% of the repeat units have hydrophilic, polar, or charged functional groups.

In some embodiments, the polymer includes a polyisobutene, a polyether, a polyester, a polyethylene, a polyimide, a polyolefin, a polyamide, a polyacrylate, a polymethacrylate, a polyvinyl pyridine, a polystyrene, a polyvinylbutyral, a polyvinyl, a polycarbonate, a cycloolefin polymer, a polysulfone, a polyetherketone, or a combination thereof.

In some embodiments, the terminal unit of the polymer is an acrylic terminal unit, such as a (meth)acrylate. In the instant specification, the polymer having the acrylic terminal unit, such as a (meth)acrylate, is sometimes referred to as “acrylic-terminated polymer” or “(meth)acrylate-terminated polymer.” The reason for having the acrylic terminal unit is that the terminal unit allows a molecule of the polymer to undergo polymerization reaction with a molecule of the monomer or another molecule of the polymer during the curing process of the curable composition. In some embodiments, one molecule of the polymer has two or more terminal units.

In some embodiments, the monomer is an acrylic monomer. In some embodiments, the acrylic monomer is a (meth)acrylate monomer. In some embodiments, the acrylic monomer is a (meth)acrylate monomer having at least one (meth)acryloyloxy group, such as one (meth)acryloyloxy group, two (meth)acryloyloxy groups, three (meth)acryloyloxy groups, or four or more (meth)acryloyloxy groups.

Examples of (meth)acrylate monomers having one (meth)acryloyloxy group include a chained alkyl (meth)acrylate (such as butyl (meth)acrylate, propyl (meth)acrylate, hexyl (meth)acrylate, or isodecyl acrylate); a cycloaliphatic alkyl (meth)acrylate (such as cyclohexyl (meth)acrylate or isobornyl (meth)acrylate); a heterocyclic alkyl (meth)acrylate (such as tetrahydrofurfuryl (meth)acrylate); an alkoxyalkyl (meth)acrylate (such as 2-methoxyethyl (meth)acrylate, 2-ethoxyethyl (meth)acrylate, ethoxyethoxy ethyl (meth)acrylate, or 2-phenoxyethyl (meth)acrylate); a hydroxy group-containing (meth)acrylate (such as 2-hydroxyethyl methacrylate, 2-hydroxypropyl (meth)acrylate, or 4-hydroxybutyl (meth)acrylate), or a combination thereof.

Examples of (meth)acrylate monomers having two (meth)acryloyloxy groups include an alkyleneglycol di(meth)acrylate (such as ethyleneglycol di(meth)acrylate, butanediol di(meth)acrylate, hexanediol di(meth)acrylate, or cyclohexanedimethanol di(meth)acrylate); a polyalkyleneglycol di(meth)acrylate (such as triethyleneglycol di (meth) acrylate, tripropyleneglycol di(meth)acrylate, tetraethyleneglycol di(meth)acrylate, or polyethyleneglycol(600) di(meth)acrylate), or a combination thereof.

Examples of (meth)acrylate monomers having three (meth)acryloyloxy groups include a tri(meth)acrylate having a branched alkyl group (such as trimethylolpropane tri(meth)acrylate or pentaerythritol tri(meth)acrylate); a tri(meth)acrylate having a branched alkylene ether group (such as glycerolpropoxy tri(meth)acrylate or trimethylolpropanetriethoxy tri(meth)acrylate); a tri(meth)acrylate having a heterocyclic ring (such as tris(2-hydroxyethyl)isocyanurate tri(meth)acrylate), or a combination thereof.

Examples of (meth)acrylate monomers having four or more (meth)acryloyloxy groups include a poly(meth)acrylate having multiple branched alkyl groups (such as di(trimethylolpropane) tetra(meth)acrylate or dipentaerythritol hexacmeth)acrylate); a poly(meth)acrylate having multiple branched alkyl groups and hydroxy groups (such as dipentaerythritol penta(meth)acrylate), or a combination thereof.

In some embodiments, the monomer is a (meth)acrylic acid ester monomer. In some embodiments, the monomer is a (meth)acrylic acid ester monomer has no fewer than 1 and no more than 5 (meth)acryloyl groups in the molecule. In some embodiments, (meth)acrylic acid ester monomer includes iso-stearyl (meth)acrylate, 4-hydroxybutyl (meth)acrylate, 2-acryloyloxy ethyl phthalate, 2-hydroxy-3-phenoxy propyl acrylate, 2-acryloyloxyethyl hexahydro phthalate, 2-ethyl-hexyl diglycol acrylate, ethoxy diethyleneglycol (meth)acrylate, triethylene glycol methyl ether (meth) acrylate, 3-(trimethoxysilyl) propyl(meth)acrylate, isobornyl acrylate, isodecyl acrylate, tetrahydrofurfuryl acrylate, phenoxyethyl acrylate, hydroxypropyl (meth) acrylate, hexanediol diacrylate, triethyleneglycol di(meth)acrylate, tripropyleneglycol diacrylate, tetraethyleneglycol di(meth)acrylate, trimethylolpropane triacrylate, trimethylolpropanetriethoxy triacrylate, glycerolpropoxytriacrylate, pentaerythritol triacrylate, di(trimethylolpropane) tetraacrylate, dipentaerythritol pentaacrylate, dipentaerythritol hexaacrylate, or a combination thereof.

In some embodiments, the above listed examples of the monomer are used either alone or in combination.

In some embodiments, the monomer is a hydrophobic monomer. As detailed above, having a hydrophobic polymer is sometimes desirable, such as when used in OLED applications. Since the hydrophobic monomer has good compatibility with a hydrophobic polymer, a hydrophobic monomer is sometimes desirable, as well. As used herein, the term “hydrophobic monomer” means that less than 5%, less than 2%, less than 1%, less than 0.1%, or less than 0.01% of the monomer molecules include a hydrophilic, polar, or charged group.

In some embodiments, the monomer functions as a viscosity reducer. The polymers described above have a viscosity higher than 6×10⁵ cps, 4×10⁵ cps, or 3×10⁵ cps, which renders the polymers alone too viscous as a curable composition for OLED production. A monomer, such as the acrylic monomer or the (meth)acrylate monomer, are normally liquids having a viscosity significantly lower than the polymer, such as a viscosity of less than 2.5×10⁵ cps, less than 2×10⁵ cps, or less than 1×10⁵ cps. As such, increasing a content of the monomer or reducing a content of the polymer in the curable composition lowers the viscosity of the curable composition, and vice versa.

In some embodiments, an amount of the monomer is more than 0 parts by weight and 50 parts by weight or less based on 100 parts by weight of the polymer. In some embodiments, an amount of the monomer ranges from 5 parts by weight to 45 parts by weight based on 100 parts by weight of the polymer. In some embodiments, an amount of the monomer ranges from 15 parts by weight to 40 parts by weight based on 100 parts by weight of the polymer. When the above polymer/monomer ratios are followed, curable compositions having desirable viscosities for OLED applications are obtained. However, since the instant specification in not limited to OLED applications, other polymer/monomer ratios can be used to achieve viscosities desirable for other applications.

In some embodiments, the monomer is capable of stabilizing the inorganic particle.

In some embodiments, the monomer is capable of dispersing the inorganic particle. As detailed above, the polymer often has high viscosity. The high viscosity of the polymer renders the direct dispersion of the inorganic particles in the polymer difficult or even impractical. The low viscosity of the monomer and the good compatibility of the monomer with the polymer allow the inorganic particles to be homogenously dispersed in the monomer before blending with the polymer and result in a curable composition in which the inorganic particles do not aggregate or precipitate during storage or during the curing process.

In some embodiments, the inorganic particle includes a metal oxide. In some embodiments, the metal oxide includes an alkali metal oxide, an alkaline earth metal oxide, aluminum oxide, or a combination thereof. In some embodiments, the metal oxide includes calcium oxide, magnesium oxide, barium oxide, aluminum oxide, or a combination thereof.

In some embodiments, the inorganic particle is an inorganic particle having a hydrophobic surface modification. Many inorganic particles, such as most metal oxides, have a hydrophilic surface. The hydrophilic surface results in poor compatibilities with hydrophobic monomers or hydrophobic polymers. The hydrophobic surface modification allows the inorganic particle, which otherwise has a poor compatibility with the monomer, the polymer, or the solvent (as detailed below), to be dispersed homogenously in the monomer, the polymer, or the solvent. The hydrophobic surface modification reduces the aggregation during the dispersion, as well.

In some embodiments, the inorganic particle is a metal oxide surface-functionalized with a silane compound. In some embodiments, the metal oxide is surface-functionalized with the silane compound by hydrolysis and condensation.

In some embodiments, the silane compound includes a hydrolysable silyl group represented by the following formula (I):

R¹—Si(OR²)₃ (I)

wherein R¹ is a group including a C1-20 substituted or unsubstituted alkyl group, an alkenyl group, a (meth)acrylate group, a substituted aryl group, or a combination thereof; and R² is independently a hydrogen atom or a C1-10 alkyl group.

In some embodiments, the silane compound includes a hydrolysable silyl group represented by the following formula (II):

R⁴—SiR⁵ₐ(OR⁶)₃₋ₐ (II)

wherein R⁴ is a group selected from a C1-20 substituted or unsubstituted alkyl group, an alkenyl group, or a substituted aryl group; and R⁵ is independently a hydrogen atom or a monovalent hydrocarbon group selected from a C1-10 alkyl group, C6-25 aryl group, or a C7-12 aralkyl group; each R⁶ is independently a hydrogen atom or a C1-10 alkyl group; and a is an integer ranging from 0 to 2.

Specific examples of silane compound useful for the surface modification of the metal oxide include a silane compound having one vinyl group, such as vinyltrimethoxysilane or vinyltriethoxysilane; a silane compound having one epoxy, such as 2-(3,4-epoxycyclohexyl)ethyltrimethoxysilane, 3 -glycidoxypropyl methyldimethoxysilane, or 3-gycidoxypropyl trimethoxysilane; a silane compound having one styrene, such as p-styryltrimethoxysilane; a silane compound having one methacryloxy, such as 3-methacryloxypropyl methyldimethoxysilane, 3-methacryloxypropyl trimethoxysilane, 3-methacryloxypropyl methyldiethoxysilane, or 3-methacryloxypropyl triethoxysilane; a silane compound having one acryloxy, such as 3-acryloxypropyl trimethoxysilane; a silane compound having one saturated alkyl chain having not fewer than 3 carbon atoms, such as triethoxy(octyl) silane, octadecyl (trimethoxy)silane, or a combination thereof.

As detailed above, in some embodiments, the curable composition is used in OLED. According to these embodiments, a transparent and clear cured product of the curable composition is desirable. Because inorganic particles having a size larger than 400 nm blocks visible light, in some embodiments, an average particle size of the inorganic particle in the curable composition ranges from 1 nm to 400 nm, such as 5 nm to 200 nm, 10 nm to 100 nm, or 20 nm to 50 nm. In some embodiments, a volume particle size D50 of the inorganic particle in the curable composition ranges from 1 nm to 400 nm, such as 5 nm to 200 nm, 10 nm to 100 nm, or 20 nm to 50 nm. In some embodiments, a volume particle size D90 of the inorganic particle in the curable composition ranges from 1 nm to 400 nm, such as 5 nm to 200 nm, 10 nm to 100 nm or 20 nm to 50 nm.

It should be noted that the above detailed average particle size or volume particle size distribution values are directed to the inorganic particle in the curable composition rather than the original inorganic particle before mixing with the monomer, the polymer, or a solvent (the solvent will be described in detail below). Mixing the inorganic particle having a particle size in nanometer ranges with the monomer, the polymer, or the solvent often causes aggregation or agglomeration of the inorganic particles and results in significantly increased average particle size and D50/D90 volume particle sizes. Therefore, in some embodiments, after mixing the inorganic particle with the monomer, the polymer, or the solvent, the mixture is homogenized to reduce the aggregation or agglomeration, thereby reaching the above average particle size or D50/D90 volume particle sizes. In some embodiments, the homogenization includes sonication, mechanical mixing, or the like.

Of course, if the curable composition is used in an application where transparency or clearness is not important, the average particle size or the D50/D90 volume particle sizes can be 400 nm or larger.

In some embodiments, an amount of the inorganic particle is more than 0 parts by weight and 30 parts by weight or less based on 100 parts by weight of the polymer. In some embodiments, the amount of the inorganic particle ranges from 0.2 part by weight to 15 parts by weight based on 100 parts by weight of the polymer. In some embodiments, the amount of the inorganic particle ranges from 1 part by weight to 10 parts by weight based on 100 parts by weight of the polymer.

In general, due to the fact that the inorganic particle is capable of absorbing moisture, the higher the amount of the inorganic particle is present, the better the moisture barrier property is shown. However, the higher amount of the inorganic particle in the curable composition would result in lower transmittance and higher haze, which are often undesirable in OLED applications. For example, when the amount of the inorganic particle exceeds 10 parts by weight based on 100 parts by weight of the polymer, the transparency sometimes drops below 75%, and the haze value could rise above 10% (measured at 450 nm). Therefore, the above ranges of the amount of the inorganic particle strike a balance between moisture barrier properties and optical properties, and are desirable for OLED related applications. However, when the curable composition is for use in non-OLED applications or OLED products designed for high humidity environments where moisture barrier properties outweigh optical properties (such as OLED used in maritime applications), the amount of the inorganic particle can exceed 30 parts by weight based on 100 parts by weight of the polymer. The amount of inorganic particle also slightly affects the viscosity of the curable composition, though to a much lesser extent than the ratio between the monomer and the polymer.

In some embodiments, the curable composition further includes a solvent.

In some embodiments, an amount of the solvent is more than 0 parts by weight and 100 parts by weight or less based on 100 parts by weight of the polymer.

As detailed above, in some embodiments, the monomer, as well as the amount of the monomer, is chosen such that the monomer reduces the viscosity of the curable composition and improves the dispersion of the inorganic particle in the curable composition. In some embodiments, the above functions of the monomer are achieved or supplemented by the solvent because, for example, the type of the monomer or the amount of the monomer is chosen for other considerations which resulted in insufficient viscosity reducing or inorganic particle dispersing capabilities of the monomer.

In some embodiments, the solvent includes an organic solvent miscible with the polymer, the monomer, and inorganic particles, and does not significantly impair the handling properties of the curable composition. In some embodiments, the solvent is an organic solvent miscible with the (meth)acrylate-terminated polymer and the (meth)acrylate monomer, and does not cause the inorganic particle to separate from the curable composition or cause precipitation or lifting.

In some embodiments, the solvent includes an ester solvent (such as methyl formate, methyl acetate, ethyl acetate, butyl acetate, or ethylene glycol monomethyl ether acetate); a saturated hydrocarbon solvent (such as pentane, hexane, or heptane); a un-saturated hydrocarbon solvent (such as toluene or xylene); an alcohol solvent (such as ethanol, isopropyl alcohol, butanol, methyl glycol, ethyl cellosolve, methyl cellosolve, or butyl cellosolve); a ketone solvent (such as methyl ethyl ketone, methyl isobutyl ketone, cyclohexanone, diacetone alcohol, or acetone); an amide solvent (such as N-methyl pyrrolidone or N,N-dimethylformamide); an ether solvent (such as tetrahydrofuran, dioxane, or dioxolane); a halogenated hydrocarbon solvent (such as methylene chloride, or dichloroethane); dimethyl sulfoxide; propylene carbonate; or the like. In some embodiments the solvent includes a single type of solvent or a combination of two or more types of solvents.

In some embodiments, the curable composition further includes a polymerization initiator. In the instant specification, the polymerization initiator is sometimes referred to as “initiator”. In general, a polymerization initiator generates a radical, a cation, an anion, or a combination thereof under certain conditions. In some embodiments, the radical, the cation, or the anion in turn serves as a catalyst for the polymerization reaction.

In some embodiments, an amount of the polymerization initiator is more than 0 parts by weight and 5 parts by weight or less based on 100 parts by weight of the polymer. In some embodiments, the amount of the initiator ranges from 0.001 part by weight to 5 parts by weight, based on 100 parts by weight of the polymer. If the amount of the initiator is less than 0.001 parts by weight, polymerization between the polymer and the monomer, between the polymer and the polymer, and/or between the monomer and the monomer is sometimes insufficient. If the amount of the initiator is more than 5 parts by weight, the excessive amount of the initiator sometimes results in undesired cracks and unsatisfactory light transmittance, or shielding or scattering of ultraviolet light or visible light, which in turn result in unsatisfactory physical and optical properties of the final products including the cured curable composition. In some embodiments, the amount of the initiator ranges from 0.01 part by weight to 2 parts by weight, based on 100 parts by weight of the polymer, to strike a balance between sufficient polymerization and satisfactory physical and optical properties.

In some embodiments, the initiator includes a photo-initiator, a thermal-initiator, or a combination thereof.

In some embodiments, the curable composition includes the photo-initiator. In some embodiments, the photo-initiator includes a photo radical initiator, a photo ionic initiator, or a combination thereof. In some embodiments, the photo-initiator generates a radical, a cation, an anion, or a combination thereof when exposed to a photoirradiation.

Exemplary photo radical initiators include a benzoin ether (such as benzoin ethyl ether); a benzophenone (such as benzophenone or 4,4-bis(N,N′-dimethylamino)benzophenone); a benzoin (such as benzoin, or a benzoinalkylether wherein the alkyl is methyl, ethyl or isopropyl); an acetophenone (such as 2.2-dimethoxyacetophenone, 2-hydroxy-2-methyl-l-phenylpropanone (Omnirad 1173), or 1,1-dichloroacetophenone); a benzylketal (such as benzylmethylketal (Irgacure 651) or 2,2-dimethoxy-2-phenylacetophenone); an anthraquinone (such as 2-methylan thraquinone, 1-chloroanthraquinone, or 2-amylan thraquinone); a bisacylphosphine oxide (such as phenyldi(2.,4,6-trimethylbenzoyl)phosphine oxide or bis(2,4,6-trimethylbenzoyl)phenylphosphine oxide (Irgacure 819)); a phosphine oxide (such as 2,4,6-trimethylbenzoyl)diphenyl phosphine oxide); a benzoylphosphine oxide (such as 2,4,6-trimethylbenzoyl-diphenylphosphine oxide); a triphenylphosphine; a α-hydroxyphenylketone (such as 1-hydroxycyclohexylphenylketone (Irgacure 184), 2-hydroxyisopropylphenylketone, or 2-hydroxy- 1-4- (2-hydroxyethoxy)phenyl-1-propanone); a thioxanthone (such as thioxanthone or 2-chlorothioxanthone); a thioxanthone derivative (such as 2-((9-oxo-9H-thioxanthen-2-yl)oxy)acetic acid); camphorquinone; an acridine derivative; a phenazine derivative; a quinoxaline derivative; or a combination thereof.

Exemplary photo ionic initiators include a diaryliodonium salt (such as, (4-methylphenyl) [4-(2-methylproyl)phenyl] iodonium hexafluorophosphate); a triarylsulfonium salt; a triarylsulfonium salt (such as, diphenyl(4-methoxypheny)sulfonium hexafluoroantimonate); an ammonium salt (such as N-ethoxy-2-methylpyridinium hexafluorophosphate); a crystal violet leuconitrile; malachite green leucohydroxide; or a combination thereof.

In some embodiments, the curable composition includes the thermal initiator, and the thermal initiator includes a thermal radical initiator, a thermal ionic initiator, or a combination thereof. In some embodiments, the thermal initiator generates a radical, a cation, an anion, or a combination thereof when exposed to heat or an elevated temperature.

Exemplary thermal radical initiators include tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy)butane, 1,1-bis (tert-butylperoxy)cyclohexane, 2,5 -bis(tert-butylperoxy)-2,5 -dimethylhexane, 2,5 -bis (tert-butylperoxy)- 2,5 -dimethyl- 3 -hexyne, bis(1- (tert-butylperoxy)- 1-methylethyl)benzene, 1,1-bis(tert-butylperoxy)-3,3,5-trimethylcyclohexane, tert-butyl hydroperoxide, tert-butyl peracetate, tert-butyl peroxide, tert-butyl peroxybenzoate, tent-butylperoxy isopropyl carbonate, cumene hydroperoxide, cyclohexanone peroxide, dicumyl peroxide, lauroyl peroxide, 2,4- pentanedione peroxide, peracetic acid, potassium persulfate, or a combination thereof.

Exemplary thermal ionic initiators include dicyandiamide, cyclohexyl tosylate, diphenyl(methyl)sulfonium tetrafluoroborate, benzyl(4-hydroxyphenyl)-methylsulfonium hexafluoroantimonate, (4-hydroxyphenyl)methyl-(2-methylbenzyl)sulfonium hexafluoroantimonate, or a combination thereof.

In some embodiments, the curable composition does not include the polymerization initiator. In some embodiments, the curable composition without the polymerization initiator is curable by, among others, an electron beam (EB). Of course, one of ordinary skill in the art would understand that the EB hardening is applicable to the curable compositions including the polymerization initiator, as well.

### Cured Product

In some embodiments, the instant specification is directed to a cured product.

In some embodiments, the cured product is cured from a curable composition the same as or similar to the curable composition as detailed above.

In some embodiments, a thickness of the cured product ranges from 20 nm to 1000 μm.

In some embodiments, a transparency of the cured product in a wavelength ranging from 400 nm to 800 nm ranges from 50% to 100%

In some embodiments, a haze of the cured product in a wavelength ranging from 400 nm to 800 nm is less than 20%.

In some embodiments, an adhesive strength of the cured product is higher than 2 kgf/cm².

### Device Including a Cured Product

In some embodiments, the instant specification is directed to a device including a cured product.

In some embodiments, the article includes a substrate, and a layer of the cured product on the substrate.

In some embodiments, the cured product is the same as or similar to those as detailed above. In some embodiments, the cured product is cured from a curable composition the same as or similar to those as detailed above.

In some embodiments, the substrate includes a glass substrate, a polymer substrate, or a combination thereof. In some embodiments, the polymer substrate includes polyester, poly(ethylene terephthalate), poly(ether imide), polyimide, polycarbonate, cellulose, or a combination thereof.

In some embodiments, the device is an OLED device. In some embodiments, the cured product is a bonding member of a thin film transistor (TFT) glass or a color filter (CF) glass of the OLED device.

### Method of Preparing a Curable Composition

In some embodiments, the instant specification is directed to a method of preparing a curable composition.

In some embodiments, the curable composition is the same as or similar to those as detailed above.

In some embodiments, preparing the curable composition includes: dispersing the inorganic particle in the monomer, thereby forming a first mixture; and mixing the first mixture and the polymer, thereby forming a second mixture. In some embodiments, the inorganic particle, the monomer, and the polymer are the same as or similar to those as detailed above.

In some embodiments, preparing the curable composition further includes, after forming the second mixture: homogenizing the second mixture to disperse the inorganic particle in the monomer. In some embodiments, homogenizing the second mixture includes: sonicating the second mixture, mechanically stirring the second mixture, or the like.

In some embodiments, preparing the curable composition further includes: preparing the inorganic particle. In some embodiments, preparing the inorganic particle includes preparing a surface modified inorganic particle. In some embodiments, preparing the inorganic particle includes performing a silane coupling reaction to a metal oxide particle, such as a metal oxide nanoparticle, thereby coating the silane compound onto the metal oxide particle.

In some embodiments, dispersing the inorganic particle in the monomer includes mixing the inorganic particle and the monomer. In some embodiments, dispersing the inorganic particle in the monomer includes mixing the inorganic particle, the monomer, and the solvent. In some embodiments, the solvent is the same as or similar to those as detailed above.

In some embodiments, preparing the curable composition further includes adding the polymerization initiator to the second mixture, thereby forming a third mixture. In some embodiments, the polymerization initiator is the same as or similar to those as detailed above.

In some embodiments, preparing the curable composition further includes, before dispersing the inorganic particle in the monomer, performing a surface modification of the inorganic particle.

As detailed above, in some embodiments, performing the surface modification of the inorganic particle comprises performing a silane coupling reaction on a metal oxide particle. In some embodiments, performing the silane coupling reaction on the metal oxide particle comprises: dispersing an uncoupled metal oxide particle in a solvent; adding a silane compound to the solvent, thereby allowing the silane coupling reaction to take place; and removing the solvent from the modified metal oxide particle. In some embodiments, dispersing the uncoupled metal oxide particle in the solvent includes: mixing the uncoupled metal oxide particle and the solvent; and homogenizing the mixture of the metal oxide particles and the solvent. In some embodiments, homogenizing the mixture includes sonicating the mixture, mechanically stirring the mixture, or the like. In some embodiments, the metal oxide and the silane compound are the same as or similar to those as detailed above.

As used herein, the “second mixture” and the “third mixture” are both examples of the curable composition. In some embodiments, for the “second mixture,” a polymerization initiator, such as an initiator detailed above, is added into the second mixture before the curable composition can be cured. In some embodiments, for the “third mixture,” an additional initiator is optional before curing.

In some embodiments, the method of preparing the curable composition further includes applying the second mixture or the third mixture onto a substrate. In some embodiments, applying the mixture includes applying the mixture onto the substrate by a solution casting, a non-solvent casting, a bar coating, a spin coating, a screen printing, a WebFlight method, a slot die, a curtain gravure, a knife coating, a dip coating, or a combination thereof.

In some embodiments, the substrate onto which the second mixture or the third mixture is applied includes a glass substrate, a polymer substrate, or a combination thereof. In some embodiments, the polymer substrate includes polyester, poly(ethylene terephthalate), poly(ether imide), polyimide, polycarbonate, cellulose, or a combination thereof.

In some embodiments, the second mixture or the third mixture is applied to the substrate such that a thickness of the mixture ranges from 20 nm to 1000 μm.

### Method of Curing a Curable Composition

In some embodiments, the instant specification is directed to a method of curing a curable composition.

In some embodiments, the curable composition is the same as or similar to those as detailed above, such as the second mixture or the third mixture as detailed above.

In some embodiments, the curable composition includes the photoinitiator, and curing the curable composition includes curing the curable composition by photoirradiation.

In some embodiments, the curable composition includes the thermal initiator, and curing the curable composition includes curing the curable composition by a thermal heating.

In some embodiments, the curable composition either includes the initiator or does not include the initiator, and curing the curable composition includes applying an electron beam (EB) to the curable composition.

### EXAMPLES

The following examples are provided to demonstrate a curable resin, in accordance with some embodiments. The examples, however, are not intended to limit the scope of the present disclosure and they should not be so interpreted.

### Materials

Magnesium oxide (MgO, 35 nm) particle was purchased from Kanto Denka Kotyo Co., Ltd. Hexane, ethanol, toluene, octadecyl (trimethoxy)silane (TODS), triethoxy(octyl) silane (TOS), and 3-(trimethoxysilyl) propylmethacrylate (TSMA) were purchased from Sigma-Aldrich. Acryloyl-terminated polyisobutylene (PIB) was obtained from Kaneka Corporation. Iso-stearyl acrylate (ISTA) was purchased from Osaka Organic Chemical Industry, Ltd.

### Measurements

### Thermogravimetric Analyzer (TGA)

A TGA (TA Q500) using TA Universal Analysis software was operated at a heating rate of 5° C/min, in the range of 50 to 800° C., at N₂ atmosphere.

### Rheology Measurement

Viscosity was measured by TA Rheometer ARES-G2. The testing condition was 25 mm and 0.1 rad cone plate at 25° C. and 2.5 rpm.

### UV Curing

UV curing was conducted by using Light hammer 6 (Heraeus Holding GmbH) equipped with a power supplier (LH6BF5). Peak irradiance at 250 mW/cm² with accumulated light amount of 2000 mJ/cm² was applied. Transparency and haze measurement

Transparency and haze were measured by Agilent Cary 6000i UV/Vis/NIR spectrometer. The haze was calculated according to ASTM D1003-13. Film thickness was ca. 10-20 um.

### Adhesion Test

The following procedure was employed to measure the strength of an adhesive spot cured between two perpendicular glass slides. Adhesion test was conducted by using an Instron Tensile testing machine, on which a Honeywell 50 lb load cell was installed. Before testing, the load cell was calibrated and checked, and the load channel was zeroed before each test. Also, the area of each adhesive spot was placed on a graph sheet as a background and imaged on ImageJ software.

A three-point bending fixture was used to carry out the tests. A pair of overhanging pins were used at the bottom fixture to clip the upper glass slide. The purpose of using the overhanging pins was to apply the load on the upper part of the fixture only to one of the two glass slides. The upper glass slide of the adhesive sample was clipped to the overhanging region of the pins. The load-applying portion of the three-point bending fixture was moved downwards at a rate of 5 mm/s, and it applied the load only to the bottom glass slide. The adhesion strength was calculated by dividing the maximum value of load applied by the surface area of the adhesive spot.

### Haze Measurement

Haze was measured according to ASTM D1003-13. The measurement was conducted by using Agilent Cary 6000i UV/Vis/NIR spectrometer.

### Humidity Treatment

Thin films coated through the pressing method were placed into a humidity chamber at 85% relative humidity (RH) at 85° C. After 200 h of exposure, those sample specimens were taken out for further testing.

### Surface Modification of Magnesium Oxide Particles

Surface Modification of MgO by 3-(trimethoxysilyl) Propyl Methacrylate (TSMA) (TSMA-MgO—H)

About 0.5 g MgO powder was dispersed into 165 mL of hexane, and the solution was sonicated for 1 h. About 1 mL of TSMA in 10 mL of hexane was added into the MgO solution. Then, the mixture was stirred at room temperature for 24 h. The mixture solution was centrifuged at 10000 rpm for 8 min and then washed with hexane twice to remove the remaining TSMA. The white powder was collected after drying the white slurry in vacuo at 70° C. for 1 day.

### Surface Modification of MgO by TSMA in Toluene (TSMA-MgO-T)

About 0.5 g MgO powder was dispersed into 50 mL of toluene, and the solution was sonic ated for 30 min. About 1 mL of TSMA with 10 mL of toluene was added into the MgO solution. Then, the mixture was stirred at 110° C. for 12 h. The mixture solution was centrifuged at 10000 rpm for 8 min and then washed with ethanol twice to remove the remaining TSMA. The white power was collected after drying the white slurry in vacuo at 70° C. for 1 day.

### Surface Modification of MgO by TSMA in Ethanol (TSMA-MgO-E)

The reaction procedure was similar to TSMA-MgO-T, except that the solvent was ethanol and the reaction condition was at 80° C. for 12 h.

Surface modification of MgO by TSMA in ethanol/water (TSMA-MgO)

About 0.5 g of MgO powder was dispersed into 50 mL ethanol, and the solution was sonicated for 30 min. Into the solution of 1 mL of TSMA in 10 mL of ethanol, 0.227 g of water was added. Then, the TSMA solution was added into the MgO solution dropwise. The mixture was stirred at 80° C. for 24 h. The resulting slurry was centrifuged at 10000 rpm for 8 min and then washed with ethanol twice to remove the remaining TSMA. The white power was collected after drying the white slurry in vacuo at 70° C. for 1 day.

Surface Modification of MgO by Triethoxy (octyl) Silane (TOS) (TOS-MgO)

About 0.5 g of MgO powder was dispersed into 50 mL of ethanol, and the solution was sonicated for 1 h. Into the solution of 4 mL of TOS in 10 mL of ethanol, 0.648 g of water was added. The TOS solution was added into the MgO solution dropwise. The purification process was same as the previous method.

Surface Modification of MgO by Octadecyl (trimethoxy) Silane (TODS) (TODS-MgO)

About 0.5 g of MgO powder was dispersed into 50 mL ethanol, and the solution was sonicated for 30 min. Into the solution of 1 mL of TODS in 10 mL of ethanol, 0.250 g of water was added. Then, the TODS solution was added into the MgO solution dropwise. The mixture was stirred at 80° C. for 24 h. The resulting slurry was centrifuged at 10000 rpm for 8 min and then washed with hexane twice to remove the remaining TSMA. The white powder was collected after drying the white slurry in vacuo at 70° C. for 1 day.

### Dispersion of Surface-Modified MgO Nanoparticles in ISTA

The surface-modified MgO nanoparticles were mixed with ISTA, and the mixture solution was sonicated in the bath sonicator and probe sonicator sequentially. The sonication duration was 1 h for each step. For the probe sonication, the solution container was placed in an ice bath to prevent overheating. The content of MgO in ISTA solution was 1, 5, 10, 20, and 30 phr (ISTA =100 parts).

### Preparation of Resin Formulation of PIB, ISTA, and Surface-Modified MgO

A pre-determined amount of PIB was mixed with pre-determined amounts of ISTA/MgO mixtures. Due to the high viscosity of PIB, the mixture was heated to 80 ° C. and was hand-mixed for 15 min. Then, the mixture resin was centrifuged at 10000 rpm for 8 min to remove all the bubbles generated during mixing. Six formulations were prepared based on the current formulation method. The formulation detail is shown in “Table 2. Thin film preparation via spin coating method, using hexane as a solvent.”

A PIB resin-based formulation was mixed with a pre-determined amount of photoinitiators (Omnirad 1173 and Omnirad 819). Then, the mixture solution was diluted with hexane, and the final content of hexane was tuned from 30 to 80 wt. %. The mixture solution was deposited onto the center of the glass slide and spread via spin coating at 3000 rpm for 1 min. The resulting thin film was dried in the oven at 60° C. for 10 sec. The films were finally cured under UV light.

Thin Film Preparation via Spin Coating Method, using Toluene as a Solvent

The sample preparation procedure was similar with a procedure using hexane, except applying toluene as a solvent and drying the applied resin at 80° C. for 5 min prior to UV curing.

Thin Film Preparation using Polyimide (PI) Thin Film as Spacer

In a 5 mL vial, about 3 g of resin was placed. A pre-determined amount of two grades of photoinitiators (i.e., 0.1 wt. % of Omirad 819 and 0.2 wt. % of Omnirad 1173, compared with the content of PIB in the mixture resin) were added into the vial. The mixture resin was mixed at 80° C., and then it was stored in the oven at 50° C. until it was used for curing.

Before use, both sides of the glass slide (supplied from VWR, 25×75 mm, 1.0 mm thickness) were cleaned with Kimwipe® using acetone. About 40 mg of mixture resin was placed at the center of the glass slide. At both edges of the top of the glass slide, two pieces of polyimide film were placed as a spacer (ca. 12 μm in thickness). Another glass slide was positioned on top of the above-mentioned glass slide. Two file binders were used to apply the pressure onto the glass slides uniformly, sandwiching the mixture resin for about 10 min. Finally, the sandwiched mixture resin was cured upon UV light exposure at 2000 mJ/cm². The dimension of the resulting cured resin was about 2 cm in diameter.

### Adhesion Test Sample Preparation

Prior to use, both sides of the glass slide (VWR, 25×75 mm, 1.0 mm thickness) were cleaned with Kimwipe® using acetone. A small drop of mixture resin was placed at the center of the glass slide. At both edges of the top of the glass slide, two pieces of polyimide film were placed as a spacer (ca. 12 pm in thickness). Another glass slide was positioned in a cross-shape on top of the above-mentioned glass slide. A heavy weight object (˜1 kg) was used as a pressor to make the coat with a uniform thickness between the two glass slides for 10 min. Finally, the sandwiched mixture resin was cured upon UV light exposure at 2000 mJ/cm². The dimension of the resulting cured resin was in the range of 6-8 mm in diameter.

### UV Curing

Light hammer 6 (Heraeus Holding GmbH) equipped with a power supplier (LH6BF5) was used for UV curing. The UV curing condition was peak irradiance at 250 mW/cm² with accumulated light amount of 2000 mJ/cm².

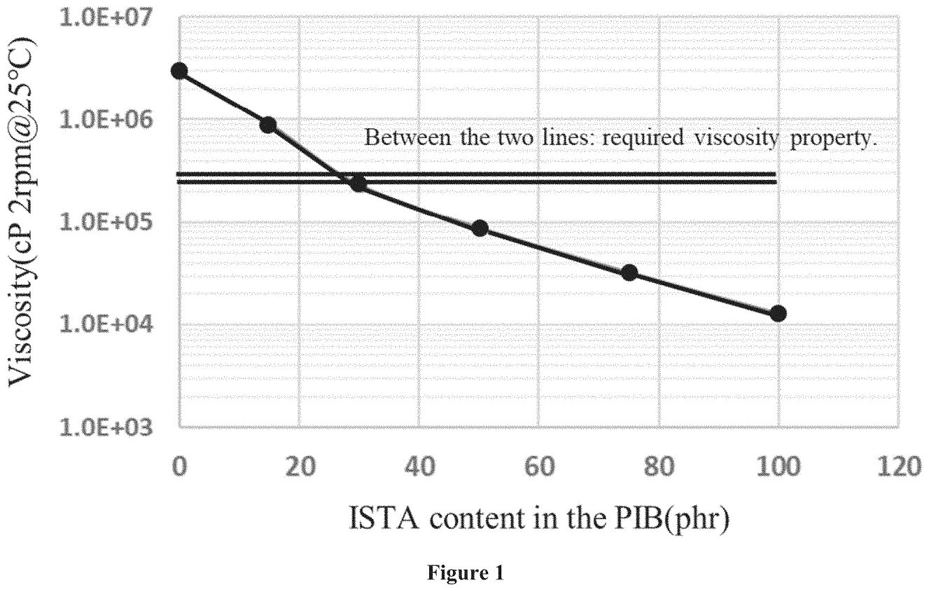

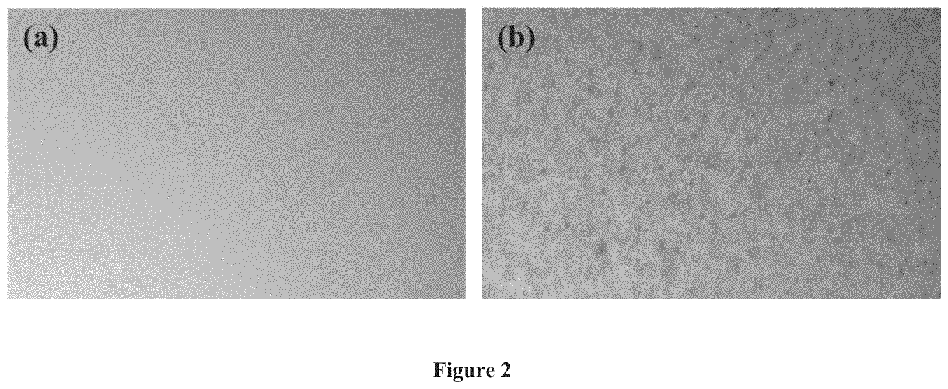

In our initial study, a formulation containing acryl-terminated PIB and moisture getter particle MgO was designed as a type of transparent adhesive for OLED side-seal application. The viscosity requirement for the transparent adhesive is in the range of 2.5×10⁵˜3×10⁵ cps. The acryl-terminated PIB has a viscosity of 3×10⁶ cps, which is 10 times higher than the desirable viscosity, so employing an acryl monomer (e.g., iso-stearyl acrylate (ISTA)) also dilutes PIB to achieve the desired viscosity. By adjusting the content of ISTA, the viscosity of the mixture resin ranged from 10⁴ to 10⁶ cps (FIG. 1). In the presence of about 26 phr of ISTA, viscosity of the mixture resin reached 3×10⁵ cps, which met the desired viscosity for our application purpose. ISTA can copolymerize with PIB under a UV-curing process. A direct dispersion of MgO nanoparticles into a PIB/ISTA mixture caused an aggregation of MgO into micrometer-sized clusters due to the incompatibility between the polar surface of MgO and non-polar PIB/ISTA mixture resin (FIG. 2).

It is well-understood that a dispersion status of nanoparticles, including MgO, CaO, SiO₂, TiO₂, etc., could be improved by modifying their surface characteristics. In this study, the extent of hydrophilicity/hydrophobicity of the MgO nanoparticle surface was adjusted by introducing silane coupling compounds covalently onto the nanoparticle surface. The hydrophobic surface of the MgO nanoparticle could be enhanced in its dispersion in a relatively non-polar media, such as acrylic monomers. Additionally, the homogeneously-dispersed MgO nanoparticles in the matrix could maximize the moisture absorption rate and also keep the resin transparent under visible light spectrum. However, the surface coating of the MgO nanoparticle may also serve as a protective layer against absorption of polar low molecular H2O. Therefore, changing the chain length and hydrophobicity of these silane molecules is a good way to tune the moisture sorption speed and efficacy of the MgO nanoparticles.

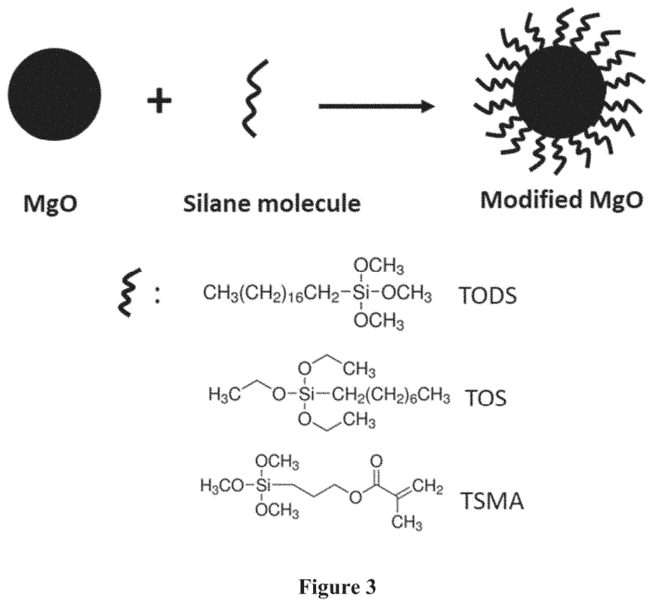

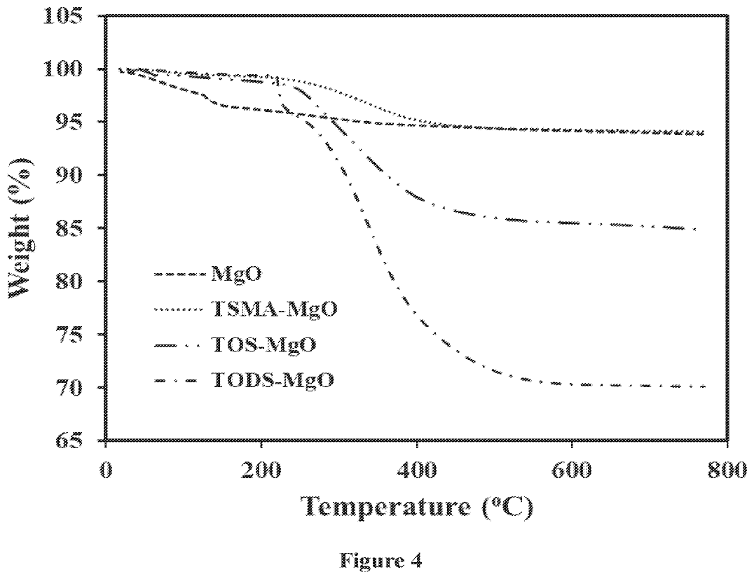

FIG. 3 describes the surface modification of the MgO nanoparticle with three different types of silane compound (i.e., TODS, TOS, or TSMA) via silane coupling reaction and the chemical structures of silane compounds used herein. There are various reaction conditions for the grafting of silane molecules. For example, hexane or toluene can be used as an alternative reaction media to carry out the coupling reaction at room temperature or elevated temperature. Different reaction conditions will lead to different grafting densities of silane molecules. Ethanol/water mixture was used as the reaction media for the silane coupling reaction, as an example. FIG. 4 shows the TGA result of MgO. The weight loss at 100° C. is from water desorption, and there is no further weight loss at higher temperature. MgO was modified by three different silane molecules in ethanol at 80° C. for 24 h. The silane molecules were pre-hydrolyzed by water to prompt the silane coupling reaction with MgO particles. The contents for TSMA, TOS, and TODS functional groups were nearly 5, 15, and 30 wt. %, respectively.

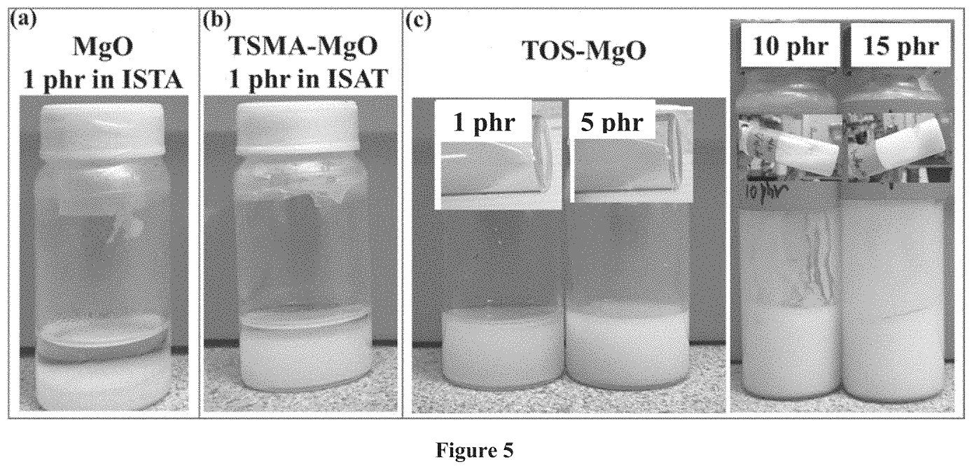

In results, TSMA-MgO displayed a good dispersion in ISTA, but not as stable as the other two surface-functionalized MgO nanoparticles. Both TOS-MgO and TODS-MgO showed homogeneous dispersions in ISTA, and their solutions could be kept stable for several days without forming precipitates (FIG. 5). Formulations of TOS-MgO in ISTA with different content of TOS-MgO were also prepared: 1, 5, 10, and 15 phr, respectively. All of them formed stable solutions, and the highest concentration of TOS-MgO could reach up to 30 phr. A further increase in the concentration of TOS-MgO resulted in a high viscosity and low followability, making probe sonication inapplicable.

TABLE 1
Moisture absorption and desorption properties of MgO and
surface-modified MgO

| | | Maximum | Weight loss | Onset of |
|---|---|---|---|---|
| | | moisture | during | moisture |
| | Type of MgO | absorption | desorption | absorption |
| | nanoparticle | (wt. %) | (wt. %) | (% RH) |
| 1 | MgO | 37.9 | 3.2 | 38 |
| 2 | TOS-MgO | 12.4 | 3.1 | 78 |
| 3 | TSMA-MgO | 6.3 | 2.2 | 79 |
| 4 | TODS-MgO | 1.8 | 0.9 | 82 |

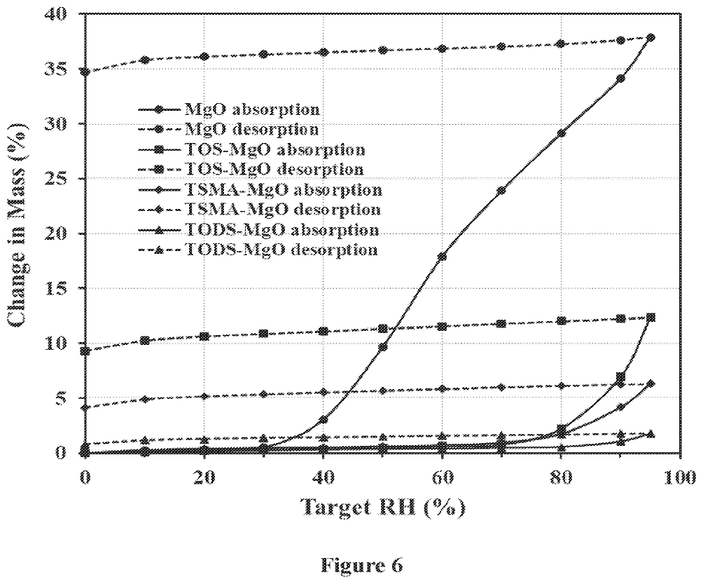

Moisture absorption and desorption behaviors of raw and surface-modified MgO were measured by dynamic vapor sorption (DVS) method (FIG. 6 and Table 1). Among the tested MgO nanoparticles, MgO displayed the highest moisture absorption capability, i.e., the moisture content up to 37.9% at 95% relative humidity (RH), and only 3.2% weight loss occurred during the desorption process. This result indicates that the moisture absorption was through chemical sorption, otherwise, most of the moisture would have desorbed through the desorption process. Compared with MgO, having the onset of moisture absorption about 38% RH, the surface-modified MgO revealed a much higher onset of moisture absorption and lower moisture content at 95%RH. It was assumed that the silane compounds attached on the surface of MgO played a role as a moisture barrier delaying the onset of moisture absorption. Meanwhile, TOS-MgO had a maximum moisture content of 12.4%, and the maximum moisture content for TSMA-MgO was nearly half of that value. TODS-MgO showed the lowest moisture content of 1.8% at 95%RH. The weight loss during desorption for TOS-MgO was 3.1%, which was very close to MgO. TSMA-MgO and TODS-MgO had a weight loss of 2.2 and 0.9% during desorption, respectively, which were lower than that of TOS-MgO. The same trend was seen with the onset of moisture absorption of surface-modified MgO. For instance, TOS-MgO had the lowest onset at 78%RH, and TODS-MgO had the highest onset at 82%RH.

It is concluded that different levels of performance of those surface-modified MgO on moisture absorption and desorption come from different grades and contents of silane compounds on the surface. According to TGA results, TODS-MgO was found to possess a higher content of silane coupling compound than TSMA-MgO and TOS-MgO, as well as the longest alkyl chain. Both factors, i.e., content and alkyl chain length of the silane coupling compound, contributed to lower the absorbed moisture content of TODS-MgO by forming a tight moisture barrier layer on the particle surface and impeding the moisture intake. Although TSMA-MgO resulted in a lower content of silane coupling compounds than TOS-MgO, the chemical structure of TSMA played a key role in the moisture absorption process. TOS-MgO had the highest water absorption content among the tested surface-modified MgO particles. Therefore, TOS-MgO was selected to prepare a formulation of PIB, ISTA, MgO, and photo-initiators.

TABLE 2
Contents of the prepared formulations containing PIB, ISTA,
TOS-MgO, and photo-initiators and their viscosities

| | | | | Photo-initiator | | |
|---|---|---|---|---|---|---|
| | | | TOS-MgO | Omnirad | Omnirad | |
| | PIB | ISTA | (parts) | 819 | 1173 | Viscosity |
| | (parts) | (parts) | (wt. %) | (parts) | (parts) | (cps) |
| Example 1 | 100 | 26 | 0 | 0.1 | 0.2 | 385000 |
| Example 2 | 100 | 26 | 0.4 (0.3%) | 0.1 | 0.2 | 362000 |
| Example 3 | 100 | 26 | 1.7 (1.3%) | 0.1 | 0.2 | 372000 |
| Example 4 | 100 | 31 | 4.0 (3.0%) | 0.1 | 0.2 | 290000 |
| Exemple 5 | 100 | 35.5 | 7.1 (5.0%) | 0.1 | 0.2 | 247000 |
| Example 6 | 100 | 38 | 11.4 (7.6%) | 0.1 | 0.2 | 234000 |

A series of formulations containing PIB, ISTA, TOS-MgO, and photo-initiators were prepared, as shown in Table 2. The content of PIB resin was in the range of 60-80 wt. %, that of ISTA was in the range of 10-40 wt. %, and that of TOS-MgO was in the range of 0-20 wt. %. The PIB-based resin could be easily applied to a substrate through various methods, such as spin coating, press coating, or bar coating, with or without solvent.

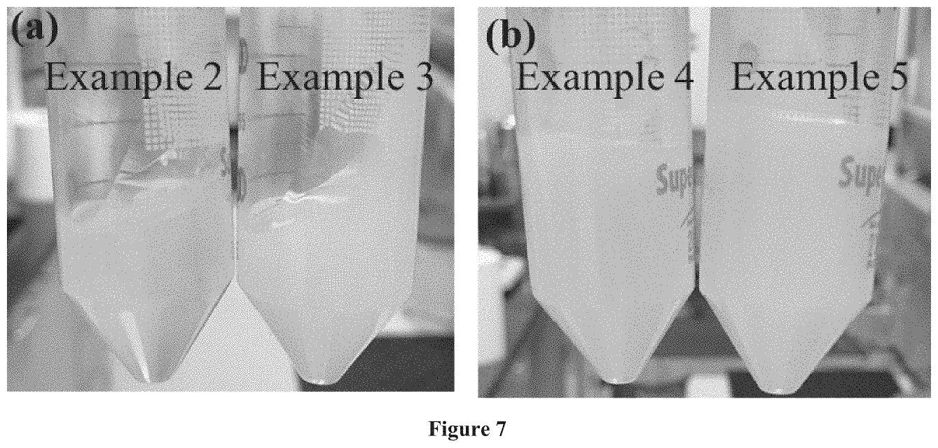

The results showed that the control sample (i.e., a formulation of PIB, ISTA, and photo-initiators) had a viscosity of 385000 cps, which was higher than expected, when the content of ISTA was about 26 phr (Table 2). Based on this observation, a series of formulations containing PIB, ISTA, TOS-MgO, and photo-initiators were prepared with a target viscosity range of 250000-300000 cps. To keep the viscosity of the final mixture within the desired range, the content of ISTA was adjusted. For Examples 4 to 6, the content of ISTA was increased from 26 phr to 30-40 phr. Due to the high viscosity of PIB, a solution of ISTA and TOS-MgO was mixed with PIB at 70° C., and then the resin mixture was centrifuged at 15000 rpm for 10 min to remove the bubbles. The final resin formulation containing 0.4 parts of TOS-MgO had a translucent appearance as shown in FIG. 7.

To minimize the undesired deactivation of photo-initiators during the UV curing process, a piece of glass slide was used to cover the applied formulation. To achieve the required thickness (10 um), two pieces of PI film (50 AV with a thickness of 12.5 um) were used as a spacer. To accurately control the sample dimension, a fixed amount of formulation in the range of 0.05-0.07 g was placed on the center of the glass slide, and then was pressed with another piece of glass slide. Finally, fully-cured sample specimens were successfully prepared by this method.

TABLE 3
Results of transparency and haze measurements of
the prepared samples

| | | Transparency | Haze |
|---|---|---|---|
| | Sample | (% at 450 nm) | (% at 450 nm) |
| 1 | Example 1 | 97 | 0.8 |
| 2 | Example 2 | 96 | 1.0 |
| 3 | Example 3 | 93 | 4.8 |
| 4 | Example 4 | 86 | 6.2 |
| 5 | Example 5 | 77 | 14.8 |
| 6 | Example 6 | 70 | 12.8 |

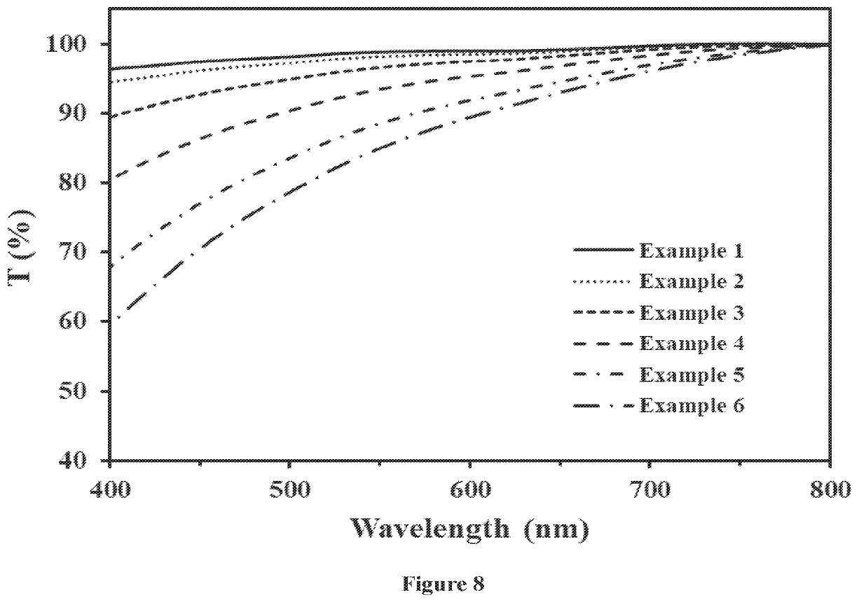

Transmittance of the cured formulations in the wavelength range of 300-800 nm is shown in FIG. 8. The curable formulation, Example 1, had the highest transmittance in the wavelength from 300 to 800 nm. With the increased content of TOS-MgO from 0.3 to 7.6%, transmittance dropped from 97 to 70% at 450 nm due to the agglomeration of TOS-MgO in micron size. Although surface modification allowed for a better dispersion of TOS-MgO in ISTA than MgO, TOS-MgO tended to form aggregates at high concentration.

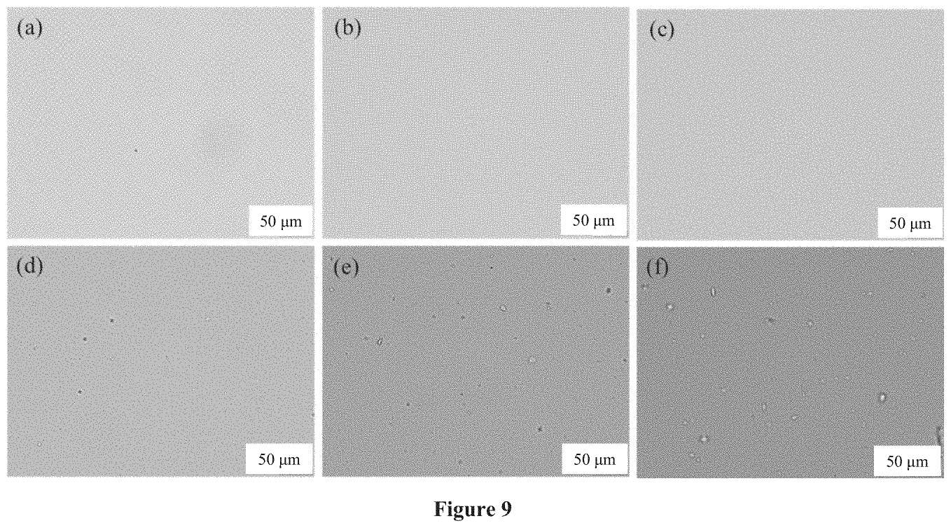

Formation of micron-sized aggregates of TOS-MgO was observed by optical microscope (OM) (FIG. 9). OM images of Examples 1 to 3 showed no aggregated particles in micron-size. However, when the content of TOS-MgO increased above 3.0 wt. %, the micro-sized aggregates became noticeable. In comparison with MgO (FIG. 2(b), TOS-MgO resulted in a better dispersion at the same particle concentration (FIG. 9(f)). The existence of micron-sized aggregates hindered transmittance by blocking the visible light. A similar trend was found on the results from haze measurement (Table 3). While Example 1 had a haze value of 0.83%, increased content of TOS-MgO, from 0.3 to 7.6%, led to an increased haze, from 1.0 to 12.8%, due to the aggregation of TOS-MgO in micron-size.

TABLE 4
Results of adhesion test of Examples 1 to 6

| | | Adhesion (kgf/cm²) | |
|---|---|---|---|
| | | Area measured by | Area measured by |
| | Sample | caliper | Image J |
| 1 | Example 1 | 2.68 ± 0.16 | 2.69 ± 0.11 |
| 2 | Example 2 | 2.82 ± 0.32 | 2.78 ± 0.43 |
| 3 | Example 3 | 2.65 ± 0.26 | 2.55 ± 0.24 |
| 4 | Example 4 | 2.54 ± 0.49 | 2.53 ± 0.55 |
| 5 | Exemple 5 | 2.63 ± 0.25 | 2.61 ± 0.05 |
| 6 | Example 6 | 3.40 ± 0.25 | 3.26 ± 0.31 |

The adhesion test results are shown in Table 4. The adhesion value was calculated by dividing the maximum load by sample area, as measured by caliper or Image J. The difference in the results obtained by two area measurement methods was minimal, and all of six samples displayed adhesion strength larger than 2 kgf/cm². Therefore, it was concluded that introduction of TOS-MgO does not affect the adhesion strength negatively.

TABLE 5
Results of transmittance, haze, and adhesion measurements
on example 1, 4 and 6 before and after humidity treatment

| | | Transmittance | | Haze | | | |
|---|---|---|---|---|---|---|---|
| | | (% at 450 nm) | | (% at 450 nm) | | Adhesion (kgf/cm²) | |
| | Sample | Before | After | Before | After | Before | After |
| 1 | Example 1 | 97 | 99 | 0.8 | 0 | 2.69 ± 0.11 | 3.41 ± 0.56 |
| 2 | Example 4 | 86 | 89 | 6.2 | 4.1 | 2.53 ± 0.55 | 3.99 ± 0.54 |
| 3 | Example 6 | 70 | 71 | 12.8 | 15.6 | 3.26 ± 0.31 | 3.56 ± 0.20 |

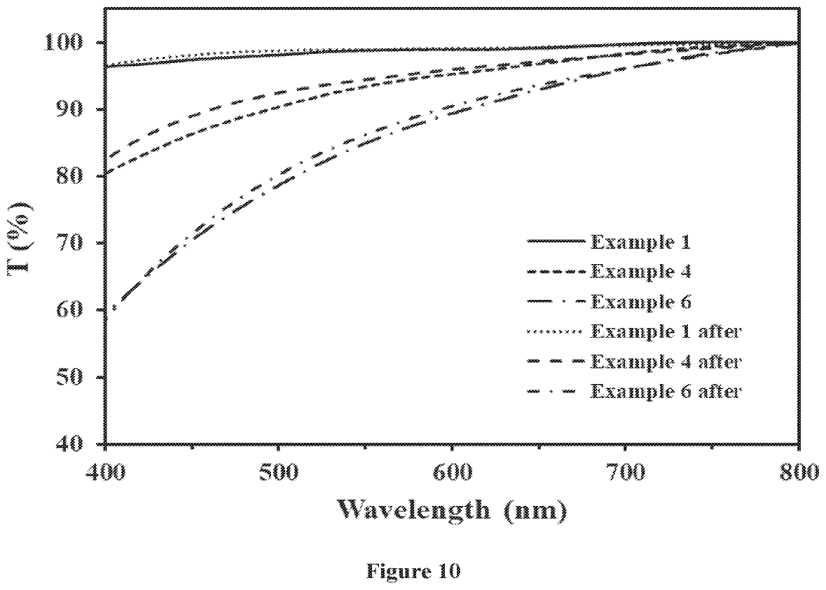

Another criterion of the devised adhesive formulation herein is the influence of moisture absorption on its performance for transmittance, haze, and adhesion properties. For this purpose, Examples 1, 4, and 6 were treated under a condition of 85° C. and 85% RH for 200 h in a humidity chamber. Interestingly, the corresponding transmittance, haze, and adhesion properties improved even more after humidity treatment. The transmittance results of samples before and after humidity treatment are shown in Table 5 and FIG. 10. All of three samples showed a higher transparency after humidity treatment. Both Examples 1 and 4 displayed lower haze values after treatment, but Example 6 had a higher value compared with the sample before treatment. As for the adhesion test, similarly, those samples after humidity treatment had a higher adhesion strength.

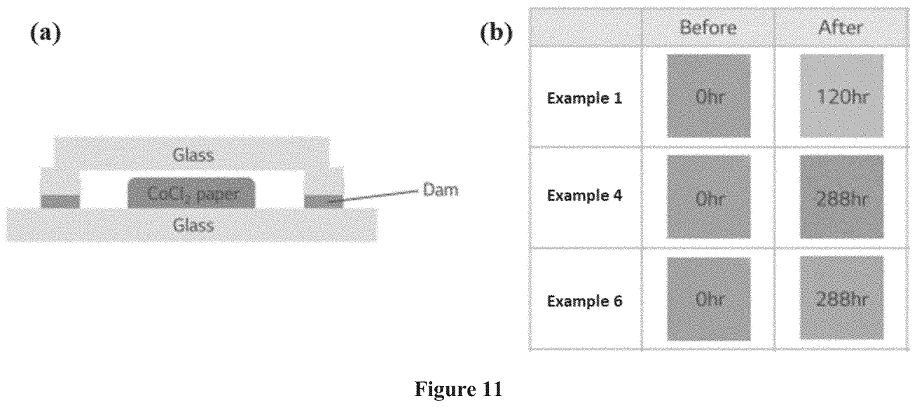

Water barrier properties of Examples 1, 4, and 6 were measured through CoCl₂ encapsulation (FIG. 11). A CoCl₂ paper was encapsulated into two pieces of glass sides that were sealed by adhesives, Examples 1, 4, and 6, respectively. The encapsulated sample specimens were placed into a humidity chamber at a condition of 85° C/85%RH. Then, color change of the CoCl₂ paper, from blue to red, was monitored as water passed through the adhesive thin film. The duration was measured according to the color change of CoCl₂ paper. In general, the barrier property of the adhesives improved with increasing MgO content. The CoCl₂ paper with Example 1 formulation turned to pink after 120 h of moisture exposure. With introduction of Example 4 formulation, the paper color changed into brown after 288 h of moisture exposure. For the sample containing Example 6 formulation, the paper color turned to green after 288 h. These results indicate that the addition of TOS-MgO significantly improved the barrier properties of the devised adhesives, and TOS-MgO worked efficiently in preventing moisture from permeating into the device.

Although only a few example embodiments have been described in detail above, those skilled in the art will readily appreciate that many modifications are possible in the example embodiments without materially departing from the present disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

It is the express intention of the applicant not to invoke 35 U.S.C. § 112, paragraph 6 for any limitations of any of the claims herein, except for those in which the claim expressly uses the words ‘means for’ together with an associated function.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A curable composition, comprising:
a polymer having a terminal unit;
a monomer polymerizable with the terminal unit of the polymer; and
an inorganic particle capable of absorbing moisture, wherein
the inorganic particle comprises magnesium oxide surface-functionalized with a silane compound, and
the silane compound comprises octadecyl (trimethoxy)silane (TODS), triethoxy(octyl) silane (TOS), or 3-(trimethoxysilyl) propylmethacrylate (TSMA).

2. The curable composition according to claim 1, wherein
an amount of the monomer is more than 0 parts by weight and 50 parts by weight or less based on 100 parts by weight of the polymer; and
an amount of the inorganic particle is more than 0 parts by weight and 30 parts by weight or less based on 100 parts by weight of the polymer.

3. The curable composition according to claim 1, wherein the polymer comprises one or more of a polyisobutene, a polyether, a polyester, a polyethylene, a polyimide, a polyolefin, a polyamide, a polyacrylate, a polymethacrylate, a polyvinyl pyridine, a polystyrene, a polyvinylbutyral, a polyvinyl, a polycarbonate, a cycloolefin polymer, a polysulfone, or a polyetherketone.

4. The curable composition according to claim 1, wherein the terminal unit is an acrylic terminal unit.

5. The curable composition according to claim 1, wherein the monomer is an acrylic monomer.

6. The curable composition according to claim 1, wherein the monomer reduces a viscosity of the polymer and stabilizes the inorganic particle.

7-8. (canceled)

9. The curable composition according to claim 1, wherein an average particle size of the inorganic particle ranges from 1 nm to 400 nm.

10. A cured product comprising a curable composition, wherein the curable composition comprises:
a polymer having a terminal unit;
a monomer polymerizable with the terminal unit of the polymer; and
an inorganic particle capable of absorbing moisture, wherein
the inorganic particle comprises magnesium oxide surface-functionalized with a silane compound, and
the silane compound comprises octadecyl (trimethoxy)silane (TODS), triethoxy(octyl) silane (TOS), or 3-(trimethoxysilyl) propylmethacrylate (TSMA).

11. The cured product according to claim 10, wherein a thickness of the cured product ranges from 20 nm to 500 μm.

12. The cured product according to claim 10, wherein a transparency of the cured product for light having a wavelength ranging from 400 nm to 800 nm ranges from 50% to 100%.

13. The cured product according to claim 10, wherein a haze of the cured product for light having a wavelength ranging from 400 nm to 800 nm is less than 20%.

14. The cured product according to claim 10, wherein an adhesive strength of the cured product is higher than 2 kgf/cm².

15. A method, comprising:
dispersing an inorganic particle in a monomer to form a first mixture; and
mixing the first mixture and a polymer to form a second mixture, wherein
the monomer is polymerizable with a terminal unit of the polymer, and
the inorganic particle is capable of absorbing moisture,
the inorganic particle comprises magnesium oxide surface-functionalized with a silane compound, and
the silane compound comprises octadecyl (trimethoxy)silane (TODS), triethoxy(octyl) silane (TOS), or 3-(trimethoxysilyl) propylmethacrylate (TSMA).

16. The method according to claim 15, wherein dispersing the inorganic particle in the monomer comprises mixing the inorganic particle, the monomer, and a solvent.

17. The method according to claim 15, further comprising:
adding a polymerization initiator to the second mixture to form a third mixture.

18. The method according to claim 17, further comprising:
curing the third mixture.

19. The method according to claim 18, wherein
the polymerization initiator comprises a photoinitiator, and
curing the third mixture comprises curing the third mixture by photoirradiation.

20. The method according to claim 18, wherein
the polymerization initiator comprises a thermal initiator, and
curing the third mixture comprises curing the third mixture by a thermal heating.

21. The curable composition according to claim 1, wherein the silane compound comprises triethoxy(octyl) silane (TOS).

22. The curable composition according to claim 21, wherein a content of the magnesium oxide surface-functionalized with the silane compound included in the curable composition is in a range of 0.4 to 3.0 wt. % of the curable composition.
